(19) United States
(12) Patent Application Publication
(10) Pub. No.: US 2026/0228626 A1
(43) Pub. Date: Aug. 6, 2026

(54) METHODS FOR SELECTING TRAINING DATA TO BE ANNOTATED

(71) Applicants: ROBERT BOSCH GmbH, Stuttgart (DE); CARIAD SE, Wolfsburg (DE)

(72) Inventor: Alexander Kugele, Kornwestheim (DE)

(21) Appl. No.: 19/443,874

(22) Filed: Jan. 8, 2026

(30) Foreign Application Priority Data
Jan. 30, 2025 (DE) 10 2025 103 736.1

(51) Int. Cl. G06N 20/00

(52) U.S. Cl. CPC G06N 20/00

(57) ABSTRACT

The invention relates to a method (100) for selecting training data to be annotated for training a machine learning system (60) in active learning, which comprises performing the following steps in an automated manner: providing (101) an output of a machine learning system (60) which has been trained on the basis of first annotated training data, providing (102) further training data to be annotated for further training of the machine learning system (60), providing (103) statistical information on the first annotated training data and/or the further training data and/or the provided output, selecting (104) the training data to be annotated from the further training data on the basis of the provided statistical information.

### FIELD OF THE INVENTION

The invention relates to a method for selecting training data to be annotated. Furthermore, the invention relates to a computer program, a device, and a storage medium for this purpose.

### BACKGROUND

In the field of machine learning and data annotation, efficient selection and labeling of unlabeled data is an essential challenge. Conventionally, the labeling of data is performed manually, which is time-consuming and expensive. In order to optimize this process, various approaches have already been developed, aiming to automate the selection of data to be prioritized for labeling.

One prominent approach is active learning, where a model specifically selects the data points it requires most to improve its performance. A selection strategy determines the data points to be labeled here.

Choosing a suitable selection strategy is one of the most important tasks of active learning since it has a significant impact on how many pieces of data need to be labeled to reach a required performance.

### SUMMARY

The subject matter of the invention is a method with the features of claim 1, a computer program with the features of claim 8, a device with the features of claim 9, and a computer-readable storage medium with the features of claim 10. Further features and details of the invention will be apparent from the associated dependent claims, the description and the drawings. In this context, features and details described in conjunction with the method according to the invention will, of course, also apply in conjunction with the computer program according to the invention, the device according to the invention, and the computer-readable storage medium according to the invention, and vice versa, so with respect to the disclosure of the invention, mutual references are also possible in all cases.

In particular, the subject matter of the invention is a method for selecting training data to be annotated for training a machine learning system in active learning.

The method according to the invention may comprise performing the following steps, preferably in an automated manner:

providing an output of the machine learning system which has been trained on the basis of first annotated training data,

providing further training data to be annotated for further training of the machine learning system,

providing statistical information on the first annotated training data and/or the further training data and/or the provided output,

selecting the training data to be annotated from the further training data on the basis of the provided statistical information.

In this way, selecting the data points for labeling may be implemented more intelligently and more efficiently since both the model output and additional statistics are taken into account.

Moreover, it is advantageous, in the context of the invention, for the statistical information to be obtained in such a way that it specifies a degree of relevance of the training data with respect to a selection strategy for active learning, in order to select, using the statistical information, the training data for training which contribute to improving the performance of the machine learning system in the best possible manner.

This results in the advantage that, by targeted selection of relevant training data, training the machine learning system may be implemented more effectively and more efficiently. Integrating statistical information allows optimizing the selection strategy for active learning and thus leads to improved performance of the machine learning system in a specific technical application.

In the context of the invention, a selection strategy may refer to a strategy in the context of active learning, defining which data points of training data are to be annotated, i.e., “labeled.” The selection strategy may provide a selection of those data points which improve the training of the machine learning system. Next, the selected data points, i.e., the data to be annotated, may be labeled, for example manually or automated, and then be mixed with the already annotated (labeled) training data set for further training, if applicable.

Furthermore, in the context of the invention, it may be provided that the selected training data is annotated in an automated manner and then merged, and preferably mixed, with the first annotated training data. It is thus possible for the annotation of the selected training data to be performed autonomously by a machine annotation system. Automatic annotation reduces manual labor and allows a more efficient expansion of the annotated data set.

Also, it may be intended that, in the providing of the statistical information for taking into account a statistic in a selection strategy for selecting the training data to be annotated in active learning, the following steps are included:

providing data, comprising at least one of the following: the first annotated training data, the further training data, the provided output,

statistically analyzing the provided data in terms of a distribution according to at least one category, which characterizes the training data and which influences a technical application of the machine learning system,

obtaining the statistical information to be provided from a result of the analysis.

In other words, the selection strategy for the training data to be annotated may be optimized by an additional statistical analysis of the available data. For example, this analysis may observe the distribution of categories within the training data, which influence the technical application of the machine learning system. The statistics obtained therefrom may then be used for a more targeted selection of relevant training data for the annotation process. This leads to a more efficient use of the resources and improved quality of the trained model.

According to an advantageous further development of the invention, it may be intended that the technical application comprises classification and preferably object detection, and the at least one category comprises at least a property, and preferably a property to be classified, of elements, most preferably objects, which are represented in the training data, wherein the analysis obtains a distribution of said properties in the training data, preferably the first annotated training data.

In other words, the machine learning system may be intended to classify objects and identify their features. The selection of the data points to be labeled takes into account the distribution of said features in the training data. This allows a more representative selection of data points for training the model, which leads to improved accuracy.

Furthermore, it may be possible to perform the selection of the training data to be annotated on the basis of the analysis and/or statistical information in such a way that the distribution in the training data to be annotated is adjusted and preferably balanced according to a predetermined criterion. In this way, a balanced distribution of the labels within the label set may be obtained. This leads to improved representativeness of the training data set and thus a more efficient training process.

It may thus also be intended that the selection of the training data to be annotated is optimized on the basis of the statistical information in such a way that a representativeness of the training data to be annotated for (further) training is increased, in particular with respect to the technical application that the machine learning system is to be trained for.

Furthermore, it is conceivable that the machine learning system is trained for a technical application comprising classification and preferably object detection with a vehicle and/or robot based on pixels of input images. These input images may be captured by the vehicle and/or robot and display an environment of the vehicle and/or robot. Here, the statistical information may be a piece of statistical information on a classification result of said classification after the training using the first annotated training data.

Thus, the machine learning system may be trained for tasks such as object detection in the environment of a vehicle or robot. The at least one piece of statistical information may reflect the distribution of objects in the input images in order to guarantee a more balanced distribution of the objects to be labeled. This leads to better understanding of the image data and thus more accurate object detection.

The invention may be used to improve the quality of the data points of training data, in particular on the basis of a machine learning system, which may comprise a machine learning model such as an artificial neural network, for example. Using this improved data set, the machine learning system and in particular the machine learning model may be trained for a technical application in an improved manner.

It is possible to use the method according to the invention with a vehicle. In other words, the technical application may relate to an application with a vehicle. For example, the vehicle may be designed as a motor vehicle and/or passenger motor vehicle and/or an at least partially automated/autonomous vehicle. The vehicle may include an interior accessory, such as for providing an autonomous driving functionality, and/or an advanced driver-assistance system. The interior accessory may be designed to control and/or accelerate and/or brake and/or steer the vehicle at least partially autonomously.

The machine learning system, in particular comprising a machine learning model, is trained for classification in particular and for object detection in particular. In this context, the training may be intended to train the machine learning system and/or the machine learning model by means of a training data set for classification, in particular for image classification, of image data such as digital images on the basis of image points and/or pixels, in particular pixel values, preferably edges or pixel attributes (of the image data). For example, the image data and/or digital images may originate from a recording by at least one sensor, preferably at least one camera, preferably of a vehicle and most preferably a camera and/or vehicle environment, during travel (of a vehicle). For example, the recording may be made by at least one camera of the vehicle. In this context, the classification may be intended to identify objects in an environment represented by the image data and/or digital images and/or to detect a traffic scenario.

The training data set may comprise the annotated training data resulting from the selected training data to be annotated after performing the annotation.

The classification may be intended for various technical applications. One example is the application in the vehicle. For example, at least one control action, preferably for a vehicle or for another technical system, may be initiated and/or performed on the basis of said classification, in particular at least one classification result.

A classification result may comprise at least one of the following results and/or be specific for at least one of the following results: a category of objects, an identification of objects, a position of objects and/or obstacles (for example in the direction of travel or adjacent to the direction of travel), a presence of obstacles, a description of a traffic scenario, a danger alarm, a number of objects, a type and/or position of lane markings and/or a lane border, a position and/or state of traffic signal systems, a position of a lane, or the like.

The statistical information described may specify a statistical distribution of said classification result and/or said results.

On the basis of the classification result, at least one control action for the vehicle may be initiated and/or performed. The control action may comprise at least one of the following: braking, steering, accelerating, an overtaking maneuver, emergency braking, activating a vehicle alarm, activating a hazard warning flasher, activating a direction indicator, light control, or the like.

For example, the classification allows detecting an obstacle, irrespective of whether it is present directly in the direction of travel or adjacent thereto. Depending on the type of locating (for example according to the expected vehicle trajectory), an appropriate control action such as braking or going round may be initiated.

Furthermore, braking may be initiated, for example, in case the classification indicates that there are obstacles in the direction of travel and/or a collision is likely to occur. It is also conceivable to detect a lane and/or a lane border on the basis of the classification in order to have the control action move the vehicle on the lane in an at least partially automated manner.

“Classification” and “image classification” may also comprise “object detection” and/or “object detection in images.” In particular, it means classification to determine whether there are objects present in certain regions of the image or not. Moreover, the terms “classification” and “image classification” may also refer to “semantic segmentation”, in particular in the form of a pixel-based classification.

Accordingly, at least one trained machine learning model, which may be used for classification and/or object detection, may result from the training. Use and, as such, inference may be intended in a vehicle, for example. The data points of the input data may be pixels of image data or be based thereon, for example, in order to thus perform classification and/or object detection of the data points on the basis of the pixels. The input data may comprise sensor and/or image data, resulting at least partially from being captured by a sensor, preferably camera sensor, and/or being at least partially synthesized, i.e., imitating the real data of a sensor, in particular. Specifically, it may be intended for the values of image points, preferably pixels, of the image data to represent an environment of a sensor and/or a vehicle and/or a traffic scenario. Classification, preferably image classification and/or object detection, may be provided on the basis of said values. This makes it possible to detect objects of the traffic scenario, for example. The image data may be images from a radar sensor and/or an ultrasonic sensor and/or a LiDAR sensor and/or a thermal imaging camera, for example. Accordingly, the images may also be formed as radar images and/or ultrasonic images and/or thermal images and/or lidar images.

Another subject matter of the invention is a computer program, in particular a computer program product, comprising commands which, when the computer program is executed by at least one computer, cause the same to perform the method according to the invention. In this way, the computer program according to the invention exhibits the same advantages as described in detail with reference to a method according to the invention.

Another subject matter of the invention is a device for data processing, configured to perform the method according to the invention. For example, at least one computer, executing the computer program according to the invention, may be provided as the device. The computer may have at least one processor for executing the computer program. A non-volatile data storage, in which the computer program is stored and from which the computer program may be read by the processor for execution, may also be provided.

Another subject matter of the invention may be a computer-readable storage medium including the computer program according to the invention and/or comprising commands which, when the computer program is executed by at least one computer, cause the same to perform the method according to the invention. For example, the storage medium is formed as a data storage such as a hard disk and/or a non-volatile storage and/or a storage card. For example, the storage medium may be integrated into the computer.

Moreover, the method according to the invention may also be designed as a computer-implemented method. Alternatively or additionally, at least one of the disclosed steps of the method may be computer-implemented and/or may be performed in an automated manner.

### BRIEF DESCRIPTION OF THE DRAWINGS

Further advantages, features and details of the invention will be apparent from the following description, in which exemplary embodiments of the invention are described individually with reference to the drawings. In this context, the features mentioned in the claims and in the description may each be relevant to the invention individually on their own or in any combination. In the drawings:

FIG. 1 shows a schematic visualization of a method, a device, a storage medium, and a computer program according to exemplary embodiments of the invention.

FIG. 2 shows an exemplary representation of the methodology of the active learning.

FIG. 3 shows a further schematic visualization of exemplary embodiments of the invention.

### DETAILED DESCRIPTION

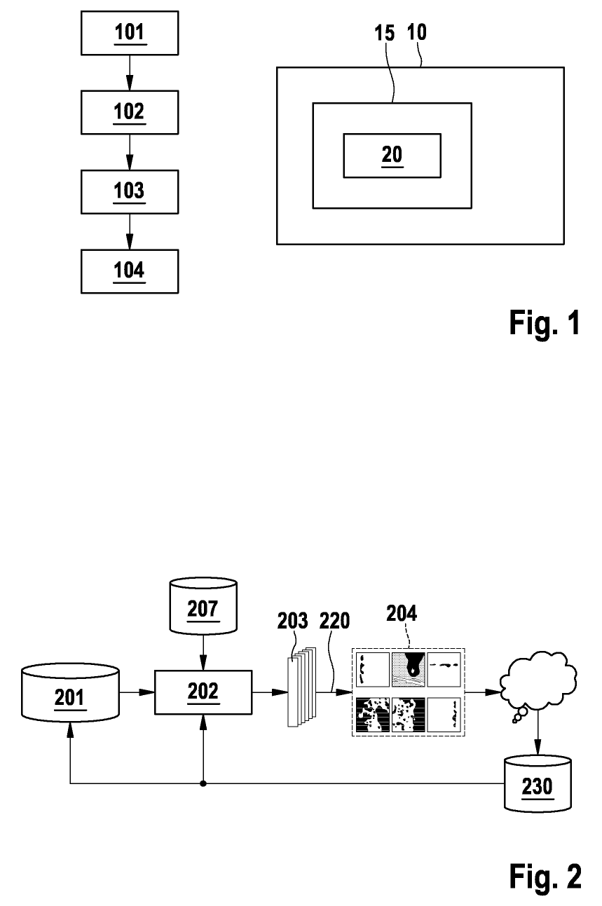

FIG. 1 illustrates a method 100, a device 10, a storage medium 15, and a computer program 20 according to exemplary embodiments of the invention in schematic fashion. Specifically, it illustrates a use of the method 100 for selecting training data to be annotated for training a machine learning system 60 in active learning.

According to a first step 101 of the method, an output of the machine learning system 60, which has been trained based on first (initial) annotated training data, may be provided. Next, according to a second step 102 of the method, providing further training data to be annotated for further training of the machine learning system 60 may be performed and/or initiated.

According to a third step 103 of the method, statistical information on the first annotated training data and/or the further training data and/or the provided output may be provided and preferably calculated.

Finally, according to a fourth step 104 of the method, selecting the training data to be annotated from the further training data on the basis of the provided statistical information may be performed.

Basically, typical selection strategies may be uncertainty-based sampling or query-by-committee (QBC), for example.

In uncertainty-based sampling, an uncertainty is assigned to each data point (for example, negative confidence in case of a classification problem – the higher the confidence, the lower the uncertainty). The selection is performed in weighted fashion with respect to the uncertainty.

In a query-by-committee (QBC) method, a committee of models based on the currently labeled data is trained. Each model outputs a prediction for the unlabeled data, and the data points with the lowest consensus among the models are selected. This lack of consensus suggests that labeling these points would be most beneficial for the model.

FIG. 2 illustrates an example of the general procedure for active learning, where a model specifically selects those data points it requires most to improve its performance. In this context, a network is trained on the basis of labeled data 207. The trained network 202 is applied to unlabeled data 201, and the output is recorded (implemented by the feature map 203 in FIG. 2). Then, a selection strategy 220, also referred to as a query strategy, determines the data points 204 to be labeled.

Here, a good query strategy 220 is able to select data points which improve the training of the neural network 202. The data points 204 selected in this manner are labeled manually or automatically and then mixed into the labeled training data set (s. 230). This loop may be repeated as often as desired. Further details are described in the scientific publication “Ren, Pengzhen, et al. ‘A survey of deep active learning.” ACM computing surveys (CSUR) 54.9 (2021): 1-40’.

In traditional methods, only the output of the trained model is considered to determine the data points to be labeled. A problem with many more complex tasks is, in most cases, the distribution of the labels. Specifically, this may mean, for example: a data set for training a 2-D box detector includes very many large boxes, but only a few small ones. This means that the selection of the data to be labeled should also include considering a number of images in order to make the distribution of the sizes of the boxes more balanced. In the present example, one could first calculate the ratio of large boxes to small boxes and then filter the data points based on the output of the trained model to proportionally favor small boxes. In this context, one could also talk about taking into account the categories (here: properties such as the sizes of the boxes) which characterize the training data and which influence the technical application of the machine learning system (detecting boxes, for example).

By taking into account additional statistics going beyond the output of the trained model, better data points might be selected for labeling. In principle, this leads to more cost-efficient labeling and/or an improvement of the model. Training time may also be reduced with higher quality of the data due to the improved selection.

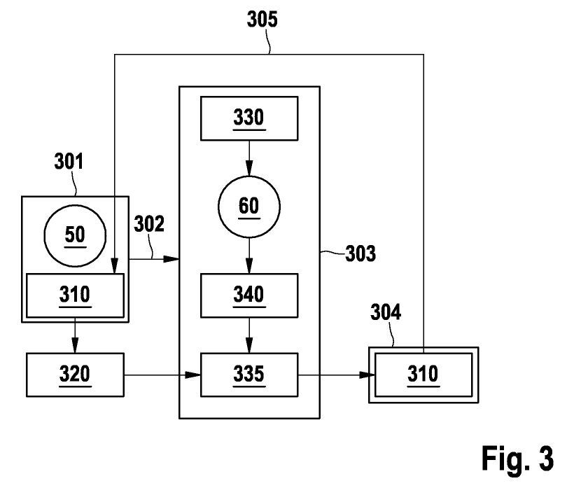

Embodiment variants of the invention may thus comprise the following steps, which are illustrated in FIG. 3. According to a first step 301, training a model 50 may be performed on the basis of labeled data 310. Then, in a second step 302, a calculation of the output of the trained model 60 may be provided based on at least a portion of the unlabeled data 330. According to a third step 303, determining the data points 335 to be labeled is performed on the basis of the output (on the basis of the calculation) AND additionally with taking into account the distribution of the labels in the training data set or a validation data set. In other words, a statistic 320 may be taken into account. For example, it may relate specifically to the distribution of the sizes or positions of 2-D boxes (bounding boxes) or the sizes and the nature of certain objects of a semantic segmentation. FIG. 3 illustrates that, in the third step 303, the trained model 60 is used for predicting 340 the labels. According to a fourth step 304, labeling the selected data 335 is performed. In a fifth step 305, a feedback loop is provided: A new model 50 may be trained with the newly created data set 310 in order to use it to select new data again.

The above discussion of embodiments describes the present invention solely by means of examples. Needless to say, individual features of the embodiments may be combined with one another freely, as long as it is technically sensible, without departing from the scope of the present invention.

1. A method for selecting training data to be annotated for training a machine learning system in active learning, which comprises performing the following steps in an automated manner:
providing an output of a machine learning system which has been trained on a basis of first annotated training data,
providing further training data to be annotated for further training of the machine learning system,
providing statistical information on the first annotated training data and/or the further training data and/or the provided output,
selecting the training data to be annotated from the further training data on the basis of the provided statistical information.

2. The method according to claim 1,
characterized in that
the statistical information is obtained in such a way that it specifies a degree of relevance of the training data with respect to a selection strategy for active learning, in order to select, using the statistical information, the training data for training which contribute to improving the performance of the machine learning system for a technical application of the machine learning system.

3. The method according to claim 1,
characterized in that
the selected training data are annotated in an automated manner and then merged with the first annotated training data.

4. The method according to claim 1,
characterized in that
in the providing of the statistical information for taking into account a statistic in a selection strategy for selecting the training data to be annotated in active learning the following steps are included:
providing data, comprising at least one of the following: the first annotated training data, the further training data, the provided output,
statistically analyzing the provided data in terms of a distribution according to at least one category, which characterizes the training data, and which influences a technical application of the machine learning system,
obtaining the statistical information to be provided from a result of the analysis.

5. The method according to claim 4,
characterized in that
the technical application comprises classification, and the at least one category comprises at least a property of elements, which are represented in the training data, wherein the analysis obtains a distribution of said properties in the training data, preferably the first annotated training data.

6. The method according to claim 5,
characterized in that
the selection of the training data to be annotated on the basis of the analysis and/or statistical information is performed in such a way that the distribution in the training data to be annotated is adjusted.

7. The method according to claim 1,
characterized in that
the machine learning system is trained for a technical application comprising classification with a vehicle and/or robot based on pixels of input images, wherein the input images are captured by the vehicle and/or robot and display an environment of the vehicle and/or robot, wherein the statistical information is a piece of statistical information on a classification result of said classification after the training using the first annotated training data.

8. (canceled)

9. A device for data processing comprising:
at least one processor; and
a tangible, non-transitory computer-readable storage medium comprising commands, which when executed by the at least one processor cause the at least one processor to:
provide an output of a machine learning system which has been trained on a basis of first annotated training data,
provide further training data to be annotated for further training of the machine learning system,
provide statistical information on the first annotated training data and/or the further training data and/or the provided output, and
select the training data to be annotated from the further training data on the basis of the provided statistical information.

10. A tangible, non-transitory computer-readable storage medium, comprising commands, which when executed by at least one computer, cause the computer to:
provide an output of a machine learning system which has been trained on a basis of first annotated training data;
provide further training data to be annotated for further training of the machine learning system;
provide statistical information on the first annotated training data and/or the further training data and/or the provided output; and
select the training data to be annotated from the further training data on the basis of the provided statistical information.

11. The method according to claim 5, wherein at least one of:
(a) the technical application further comprises object detection;
(b) the at least one category comprises a property to be classified;
(c) the elements comprise objects; or
(d) the training data comprises the first annotated training data.

12. The method according to claim 6, wherein the distribution in the training data to be annotated is balanced according to a predetermined criterion.

13. The method according to claim 7, wherein the machine learning system is trained for the technical application comprising object detection with the vehicle and/or the robot based on the pixels of the input images.
